(19) United States
(12) Patent Application Publication
(10) Pub. No.: US 2015/0109245 A1
(43) Pub. Date: Apr. 23, 2015

(54) TOUCH PANEL

(71) Applicants: Rone-Hwa Chou, Nantou County (TW); Chong-Yang Fang, Taichung City (TW); Ching-Fu Hsu, Taichung City (TW); Ying-Ching Tseng, Taichung City (TW); Hen-Ta Kang, Taichung City (TW); Fa-Chen Wu, Taichung City (TW); Wen-Chun Wang, Taichung City (TW)

(72) Inventors: Rone-Hwa Chou, Nantou County (TW); Chong-Yang Fang, Taichung City (TW); Ching-Fu Hsu, Taichung City (TW); Ying-Ching Tseng, Taichung City (TW); Hen-Ta Kang, Taichung City (TW); Fa-Chen Wu, Taichung City (TW); Wen-Chun Wang, Taichung City (TW)

(73) Assignee: WINTEK CORPORATION, Taichung City (TW)

(21) Appl. No.: 14/516,593

(22) Filed: Oct. 17, 2014

(30) Foreign Application Priority Data
Oct. 18, 2013 (TW) 102137878
Aug. 29, 2014 (TW) 103129877

(51) Int. Cl. G06F 3/044

(52) U.S. Cl. CPC G06F 3/044
USPC 345/174

(57) ABSTRACT

A touch panel including a substrate, first electrodes and second electrodes is provided. The first electrodes and the second electrodes are electrically insulated from each other and are disposed on the substrate. Each first electrode includes first electrode pads and first connecting lines, and the first connecting lines connect adjacent two of the first electrode pads in series. Each second electrode includes second electrode pads and second connecting lines, and the second connecting lines connect adjacent two of the second electrode pads in series. An outer contour of each first electrode pad is defined by a first zigzag line, an outer contour of each second electrode pad is defined by a second zigzag line, and the first zigzag line and the second zigzag line located at a boundary between the first electrode and the second electrode are parallel or partially parallel to each other.

### CROSS-REFERENCE TO RELATED APPLICATION

This application claims the priority benefit of Taiwan application serial no. 102137878, filed on Oct. 18, 2013, and Taiwan application serial no. 103129877, filed on Aug. 29, 2014. The entirety of each of the above-mentioned patent applications is hereby incorporated by reference herein and made a part of this specification.

### BACKGROUND OF THE INVENTION

1. Field of the Invention

The invention relates to a panel, and more particularly, to a touch panel.

2. Description of Related Art

With rapid developments and applications of the information technology, wireless mobile telecommunication, and information appliances, the input devices of many information products are changed from traditional input device such as a traditional keyboard, a mouse to a touch panel, so as to satisfy the requirements of convenience in carrying, light weight, and user-friendly operations.

The touch panel is generally categorized into a resistive touch panel and a capacitive touch panel. Take the capacitive touch panel as an example, the capacitive touch panel usually includes a plurality of transverse electrodes and a plurality of longitudinal electrodes which are in staggered arrangement, and said electrodes are generally composed of a plurality electrode pads and a plurality of connecting lines. In consideration of applications for the touch panel (e.g., used together with a display panel), a transparent conductive material such as indium tin oxide, is usually selected as a material of the electrode pads. However, indium is a rare metal and cannot be easily obtained for such material is prone to restriction of its place of origin. Moreover, since a price of indium is relatively expensive, manufacturing costs for the touch panel cannot be reduced, thus it is disadvantageous in commercial competitiveness.

In addition, since connecting portions of the transverse electrodes and connecting portions of the longitudinal electrodes are intersected with each other, it is required to dispose an insulation pattern on an intersection between the two, so that the transverse electrodes may be electrically insulated from the longitudinal electrodes. In this case, connecting portions of one of the transverse electrodes and the longitudinal electrodes need to cross over the insulation pattern to electrically connect the electrodes located at two opposite sides of the insulation pattern, and said connecting portions are usually composed of a metal bridge having a favorable conductivity. However, a difference between a reflective index of the metal bridge and a reflective index of the electrode pad is overly huge. Therefore, the metal bridge between the intersections of transverse electrodes and the longitudinal electrodes may be easily visualized by a user. Furthermore, a reflective index of the substrate and reflective indexes of the electrode pads and the connecting are also different. Therefore, contour outlines of the electrode pads and the connecting lines may also be easily visualized by the user due to boundaries between the electrode pads being too obvious under said arrangement for the electrodes. Accordingly, how to make the touch panel to provide a favorable visual effect while maintaining the manufacturing costs is indeed a trend for the future.

### SUMMARY OF THE INVENTION

The present invention is directed to a touch panel capable of providing a favorable visual effect.

A touch panel of the invention includes a substrate, a plurality of first electrodes and a plurality of second electrodes. The first electrode is disposed on the substrate. Each of the first electrodes includes a plurality of first mesh patterns connected to another and a plurality of first electrode pads and a plurality of first connecting lines, and the first connecting lines connect adjacent two of the first electrode pads in series. The second electrodes are electrically insulated from the first electrodes and disposed on the substrate. Each of the second electrodes includes a plurality of second mesh patterns connected to another and a plurality of second electrode pads and a plurality of second connecting lines, and the second connecting lines connect adjacent two of the second electrode pads in series. An outer contour of each first electrode pad is defined by a first zigzag line, an outer contour of each second electrode pad is defined by a second zigzag line, and the first zigzag line and the second zigzag line located at a boundary of the first electrode and the second electrode are parallel or partially parallel to each other.

A touch panel of the invention includes a substrate, a plurality of first electrodes and a plurality of second electrodes. The first electrode is disposed on the substrate. Each of the first electrodes includes a plurality of first mesh patterns connected to another and a plurality of first electrode pads and a plurality of first connecting lines, and the first connecting lines connect adjacent two of the first electrode pads in series. The second electrodes are electrically insulated from the first electrodes and disposed on the substrate. Each of the second electrodes includes a plurality of second mesh patterns connected to another and a plurality of second electrode pads and a plurality of second connecting lines, and the second connecting lines connect adjacent two of the second electrode pads in series. An outer contour of each first electrode pad is defined by a first zigzag line, an outer contour of each second electrode pad is defined by a second zigzag line, and the first zigzag line and the second zigzag line located at a boundary of the first electrode and the second electrode are overlapped or partially overlapped with each other.

Based on the above, the touch panel of the invention composes the first and the second electrodes by using the mesh patterns of the metal material. Accordingly, in comparison with the touch panel using indium tin oxide containing rare earth element indium as the material of the electrode pads, the material used in the invention may be easily obtained, and a price of the material is also inexpensive. Moreover, the intersections of the first and the second electrodes are formed by the mesh patterns being overlapped, and the outer contours of the first electrode pads and the second electrode pads are defined by the zigzag lines. Therefore, the touch panel of the invention may facilitate in lowering a probability of the outer contours of the first and the second electrodes and the intersections being noticed by the user, so that the touch panel may provide a favorable visual effect.

To make the above features and advantages of the disclosure more comprehensible, several embodiments accompanied with drawings are described in detail as follows.

### BRIEF DESCRIPTION OF THE DRAWINGS

FIG. 1 is a schematically top view of a touch panel according to first embodiment of the invention.

FIGS. 2A and 2B are schematically sectional views along section lines A-A′ and B-B′ depicted in FIG. 1, respectively.

FIG. 3A is an explosion diagram of the first electrode and the second electrode in a region A depicted FIG. 1.

FIG. 3B is an enlarged view of the region A depicted in FIG. 1.

FIGS. 4A-4G illustrate other electrode patterns and stacking forms of the first electrode and the second electrode.

FIG. 5 is a schematically sectional view of a touch panel according to second embodiment of the invention.

FIG. 6 is a schematically sectional view of a touch panel according to third embodiment of the invention.

FIG. 7 is a schematically sectional view of a touch panel according to fourth embodiment of the invention.

FIG. 8 is a schematically sectional view of a touch panel according to fifth embodiment of the invention.

FIG. 9 is a schematically sectional view of a touch panel according to sixth embodiment of the invention.

FIGS. 10-12 are implementations of a touch display panel applying the touch panel of the invention.

### DESCRIPTION OF THE EMBODIMENTS

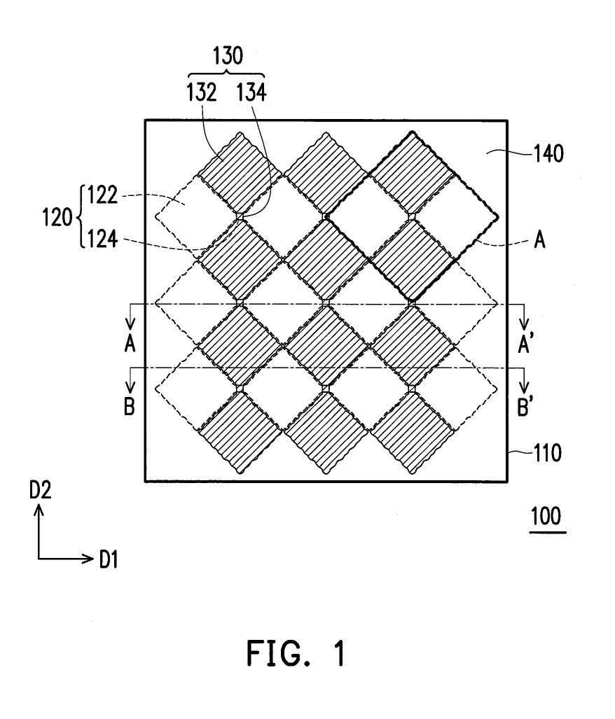

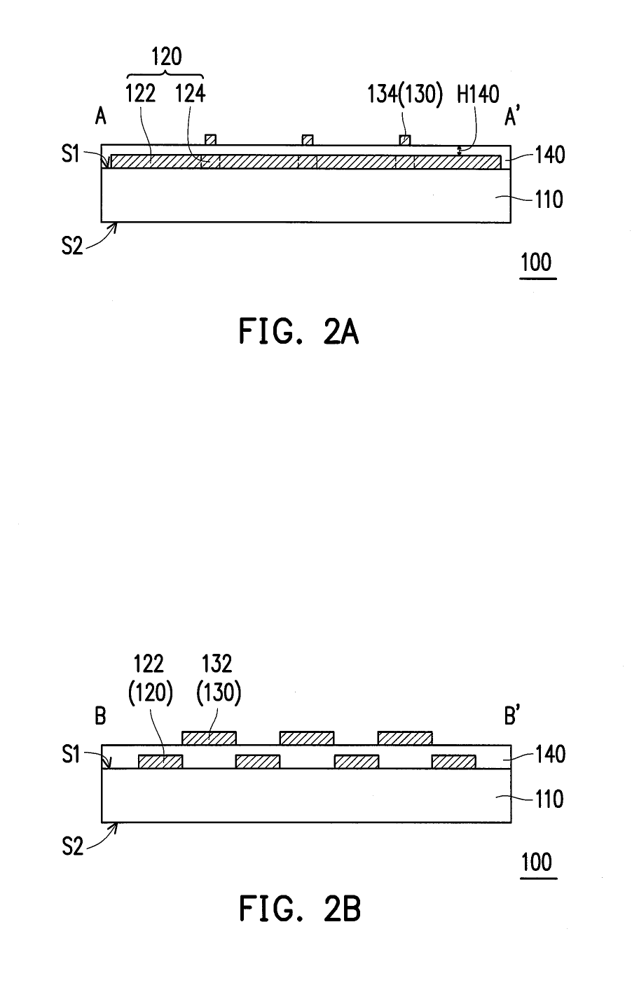

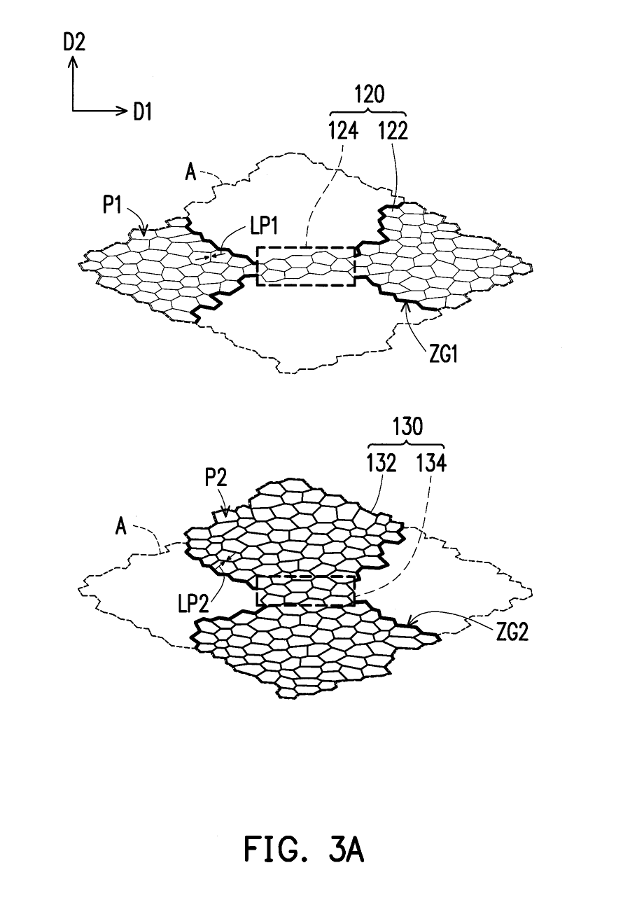

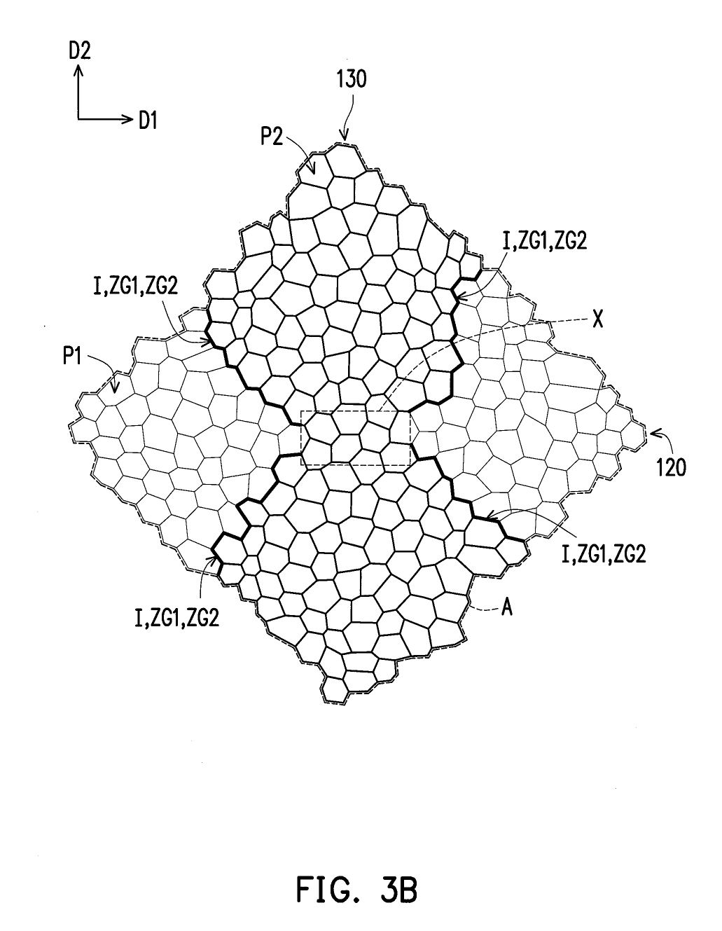

FIG. 1 is a schematic top view of a touch panel according to first embodiment of the invention. FIGS. 2A and 2B are schematically sectional views along section lines A-A′ and B-B′ depicted in FIG. 1, respectively. FIG. 3A is an explosion diagram of the first electrode and the second electrode in a region A depicted in FIGS. 1, and 3B is an enlarged view of the region A depicted in FIG. 1. Referring to FIGS. 1, 2A and 2B, a touch panel 100 of the present embodiment includes a substrate 110, a plurality of first electrodes 120 and a plurality of second electrodes 130.

The first electrodes 120 are disposed on the substrate 110. Each of the first electrodes 120 includes a plurality of first electrode pads 122 and a plurality of first connecting lines 124, and each of the first connecting lines 124 connects adjacent two of the first electrode pads 122 in series. The second electrodes 130 are electrically insulated from the first electrodes 120 and disposed on the substrate 110, and each of the second electrodes 130 includes a plurality of second electrode pads 132 and a plurality of connecting lines 134. Each of the second connecting lines 134 connects adjacent two of the second electrode pads 132 in series. In the present embodiment, each first electrode 120 is, for example, respectively extended along a first direction D1 and the first electrode 120 are arranged along a second direction D2. Each of the second electrodes 130 is, for example, extended along the second direction D2 and the second electrodes 130 are arranged along the first direction D1. For example, the first direction D1 is, but not limited to, perpendicular to the second direction D2.

In the present embodiment, a material of the first electrode 120 and the second electrode 130 is a metal material. For instance, the material of the first electrode 120 and second electrode 130 may be one selected from materials including copper, silver, aluminum, chromium, titanium, molybdenum, or a stack structure of above-said materials, or an alloy containing at least two of the above-said materials. For instance, the material of the first electrode 120 and the second electrode 130 may be a stack structure of three materials being Mo/Al/Mo. Alternatively, the material of the first electrode 120 and the second electrode 130 may also be a stack structure of three materials such as ITO/Ag/ITO. A material and a number of layers of the stack structure are not particularly limited in the invention, and it falls in the protection scope of the invention as long as the material has a favorable conductivity.

The first electrode 120 and the second electrode 130 of the present embodiment may be selected from the metal material in substitution for indium tin oxide. Therefore, it has the advantages of favorable conductivity, easy acquirement, and relative inexpensiveness. In addition, a manufacturing process of the touch panel 100 may also be simplified by forming the first electrodes 120 and the second electrodes 130 while patterning a wiring (not illustrated) at periphery of the touch panel 100.

Referring to FIG. 3A, since a light transmittance of metal is low, in the present embodiment, the first electrodes 120 are designed in form of, for example, a plurality of first mesh patterns P1 connected to one another, and the second electrodes 130 are designed in form of, for example, a plurality of second mesh patterns P2 connected to one another, so as to increase the light transmittances of the first electrodes 120 and the second electrodes 130.

Each of the first mesh patterns P1 and the second mesh patterns P2 is a closed pattern. The term “closed” refers to a status in which line segments composing the first mesh patterns P1 or the second mesh patterns P2 are connected to one another without any disconnection. For instance, the first mesh patterns P1 of each of the first electrodes 120 and the second mesh patterns P2 of each of the second electrodes 130 may be regular polygons or irregular polygons. Namely, the first mesh patterns P1 (the second mesh patterns P2) of each of the first electrodes 120 (each of the second electrodes 130) may include polygons having an identical size and an identical shape, or polygons having different sizes and/or different shapes. For instance, a shape of the first mesh patterns P1 (the second mesh patterns P2) of each of the first electrodes 120 (each of the second electrodes 130) may be a circle, a triangle, a tetragon, a pentagon, a hexagon, or a combination of two of the above. A shape of the second mesh patterns P2 of each of the second electrodes 130 may also be a circle, a triangle, a tetragon, pentagon, a hexagon, or a combination of two of the above.

Referring to FIG. 2A and FIG. 2B, the substrate 110 of the present embodiment is, for example, used as a cover plate. In other words, the first electrode 120 and the second electrode 130 are, for example, disposed on the same surface S1 of the substrate 110, but the first electrodes 120 and the second electrodes 130 are located at different layers. In addition, the touch panel 100 of the present embodiment may further include an insulation layer 140 disposed between the first electrodes 120 and the second electrodes 130, so that the first electrodes 120 are electrically insulated from the second electrodes 130. The cover plate may include a glass cover plate, a plastic cover plate or other cover plates formed by hard materials with high mechanical strength and capabilities of protecting, covering or beautifying the corresponding device, such as a tempered glass being processed physically or chemically. The cover plate may be of a plane shape or a curved shape, or a combination of the two, such as a 2.5D glass, but the invention is not limited thereto. A decorative layer may be disposed on at least one side of the cover plate to cover metal wirings or cover pins configured to electrically connect to a FPC.

More specifically, the insulation layer 140 is disposed on the substrate 110, and both the first electrodes 120 and the second electrodes 130 are located on the insulation layer 140. In order to achieve an effect of touch detection, the thickness H140 of the insulation layer 140 is, for example, less than or equal to 100 time a line width (LP1 or LP2) of the first mesh patterns P1 or the second mesh patterns P2 as depicted in FIG. 3A. Meanwhile, the line width LP1 of the first mesh patterns P1 or the line width LP2 of the second mesh patterns P2 may be designed to fall within a range between 0.1 μm to 500 μm, and more preferably, to fall within a range that is invisible to human eyes. For example, the line widths LP1 and LP2 may be designed to fall between 0.1 μm to 10 μm, so as to prevent a visual effect of the display panel 100 from being influenced. For instance, the thickness H140 of the insulation layer 140 falls within a range between 0.1 μm to 90 μm. Preferably, the thickness H140 of the insulation layer 140 falls within a range between 1 μm to 90 μm. In addition, a difference between refractive indexes of the insulation layer 140 and the substrate 110 is, for example, less than 30%, so as to avoid generating undesirable visual effect.

Referring to FIG. 3A and FIG. 3B, the first electrode pads 122 and the first connecting lines 124 are, but not limited to, composed of first mesh patterns P1 being closed and connected. The second electrode pads 132 and the second connecting lines 134 are, but not limited to, composed of the second mesh patterns P2 being closed and connected. However, the invention is not limited thereto. In another example, the first connecting lines 124 may also be composed of single one of the first mesh patterns P1, or composed of one or more line segments. The second connecting lines 134 may also be composed of single one of the second mesh patterns P2, or composed of one or more line segments. The line segments may be a straight line or a bending line.

In addition, the first electrodes 120 and the second electrodes 130 are intersected with each other. Furthermore, in the present embodiment, the second connecting lines 134 are intersected with the first connecting lines 124. In the present embodiment, the second connecting lines 134 are composed of the second mesh patterns P2 being closed and connected, and the first connecting lines 124 are composed of the first mesh patterns P1 being closed and connected. Therefore, the second mesh patterns P2 composing the second connecting lines 134, for example, overlap with the first mesh patterns P1 composing the first connecting lines 124 at intersections X of the first electrodes 120 and the second electrodes 130. In other embodiments, in case the first connecting line 124 and the second connecting line 134 are composed of single one of the first mesh patterns P1 being closed and the single one of the second mesh patterns P2 being closed, respectively, the second mesh pattern P2 composing the second connecting line 134, for example, overlap with the first mesh pattern P1 composing the first connecting line 124 at the intersection X of the first electrode 120 and the second electrode 130. On the other hand, in case the first connecting lines 124 and the second connecting lines 134 are composed of one or more line segments, respectively, and the one or more line segments composing the second connecting line 134, for example, overlap with the one or more line segments composing the first connecting line 124 at the intersections X of the first electrodes 120 and the second electrodes 130.

In the present embodiment, the first mesh patterns P1 are, for example, only overlapped with the second mesh patterns P2 at the intersections X of the first electrodes 120 and the second electrodes 130. Furthermore, the first mesh pattern P1 at the intersection X and the corresponding second mesh pattern P2 have an identical contour outline, and sidewalls of the two are aligned to each other. In addition, the first mesh patterns P1 located at the boundaries I between the first electrode pads 122 and the second electrode pads 132 are, but not limited to, not overlapped with the second mesh patterns P2 located at the boundaries I between the first electrode pads 122 and the second electrode pads 132. Further, the sidewalls of the first mesh patterns P1 and the second mesh patterns P2 located at boundaries I between the first electrode pads 122 and the second electrode pads 132 are, for example, aligned to each other. More specifically, the sidewalls of the first mesh patterns P1 adjacent to the boundaries I are, for example, aligned to the sidewalls of the second mesh patterns P2 adjacent to the boundaries I (as shown in FIG. 2B). However, the invention is not limited thereto.

In other embodiments, the first mesh patterns P1 located at edges of the first electrode pads 122 may also be overlapped with the second mesh patterns P2 located at edges of the second electrode pads 132, and the sidewalls of the first mesh patterns P1 and the second mesh patterns P2 being overlapped are aligned to each other.

In view of FIG. 3A and FIG. 3B, it can be known that the intersections X of the first electrodes 120 and the second electrodes 130 are formed by the irregular first mesh patterns P1 and the irregular second mesh patterns P2 being overlapped, and the boundaries I between the first electrode pads 122 and the second electrode pads 132 are defined by zigzag lines. In other words, the boundaries I between the first electrode pads 122 and the second electrode pads 132 are not defined by a straight line. More specifically, as shown in FIG. 3A, an outer contour of each of the first electrode pads 122 is defined by a first zigzag line ZG1, and an outer contour of each of the second electrode pads 132 is defined by a second zigzag line ZG2. The first zigzag line ZG1 zigzags, for example, along routing of the first mesh patterns P1 located at the boundaries I between the first electrode pads 122 and the second electrode pads 132, and the second zigzag line ZG2 zigzags, for example, along routing of the second mesh patterns P2 located at the boundaries I between the first electrode pads 122 and the second electrode pads 132. Accordingly, zigzag conditions of the first zigzag line ZG1 and the second zigzag line ZG2 are changed according to average side lengths of the first mesh patterns P1 and the second mesh patterns P2 for example. In the present embodiment, the average side lengths of the first mesh patterns P1 and the second mesh patterns P2 fall within a range between 50 μm to 300 μm for example.

In addition, as shown in FIG. 3B, the first zigzag line ZG1 and the second zigzag line ZG2 are not intersected with each other. In the present embodiment, the first zigzag line ZG1 and the second zigzag line ZG2 located at the boundaries I between the first electrodes 120 and the second electrodes 130 are, but not limited to, overlapped with each other. In other embodiments, the first zigzag line ZG1 and the second zigzag line ZG2 located at the boundaries I between the first electrodes 120 and the second electrodes 130 may also be partially overlapped with each other, or parallel or partially parallel to each other.

Since the boundaries I between the first electrodes 120 and the second electrodes 130 respectively located a upper layer and a lower layer are defined by the zigzag lines (including the first zigzag line ZG1 and the second zigzag line ZG2), besides that problem of connecting mark at the intersections X being easily noticed by the users may be solved, the touch panel 100 of the present embodiment may also facilitate in lowering a probability of the outer contours of the first electrodes 120 and the second electrodes 130 being noticed by the users, so that the touch panel 100 may provide a favorable visual effect.

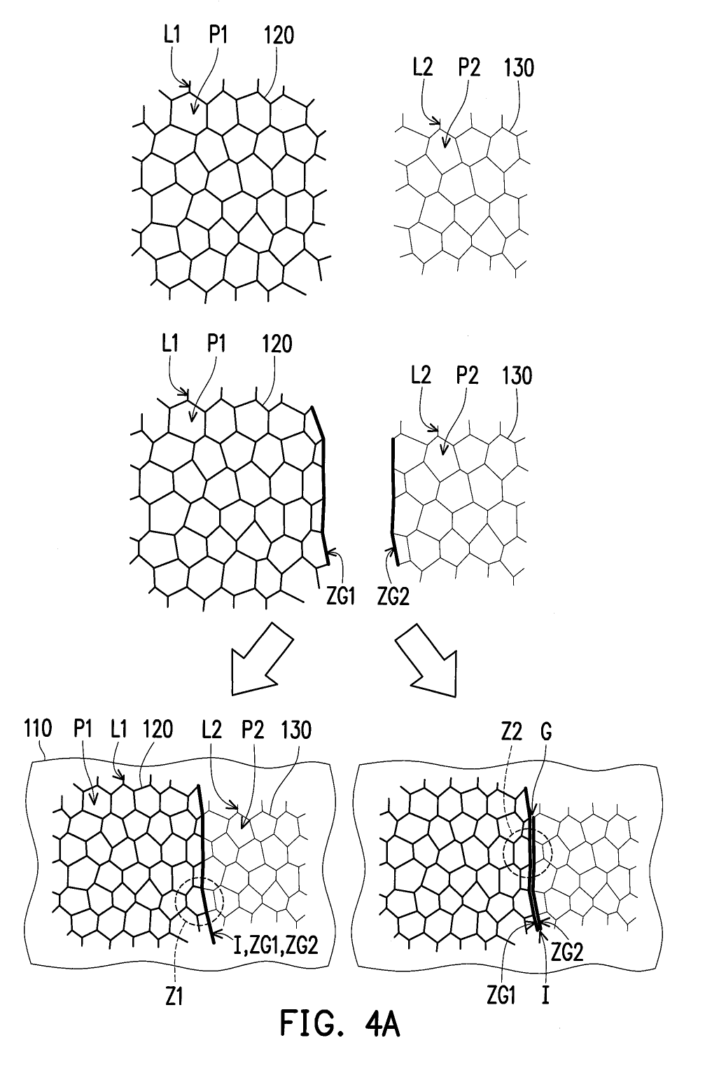

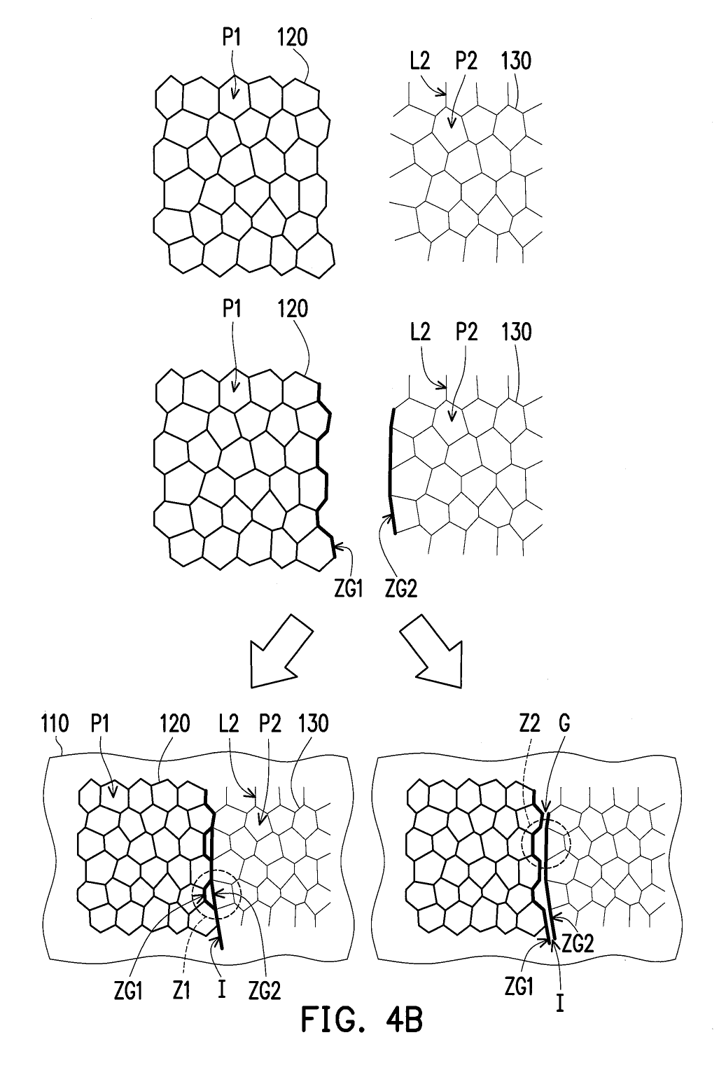

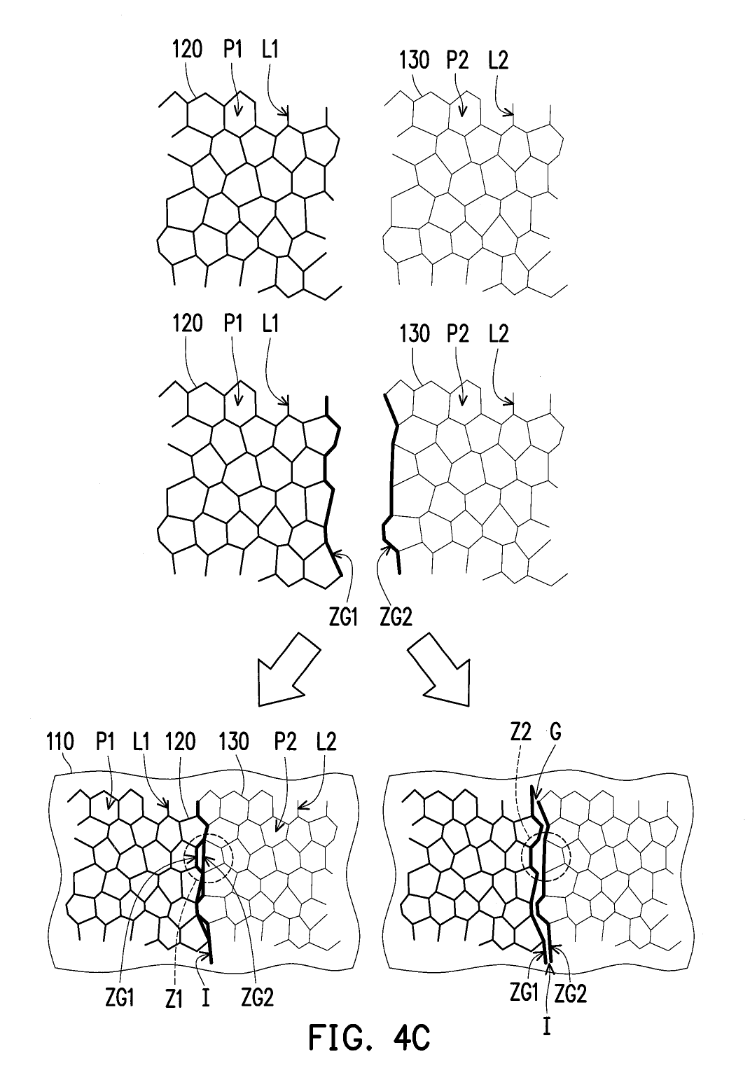

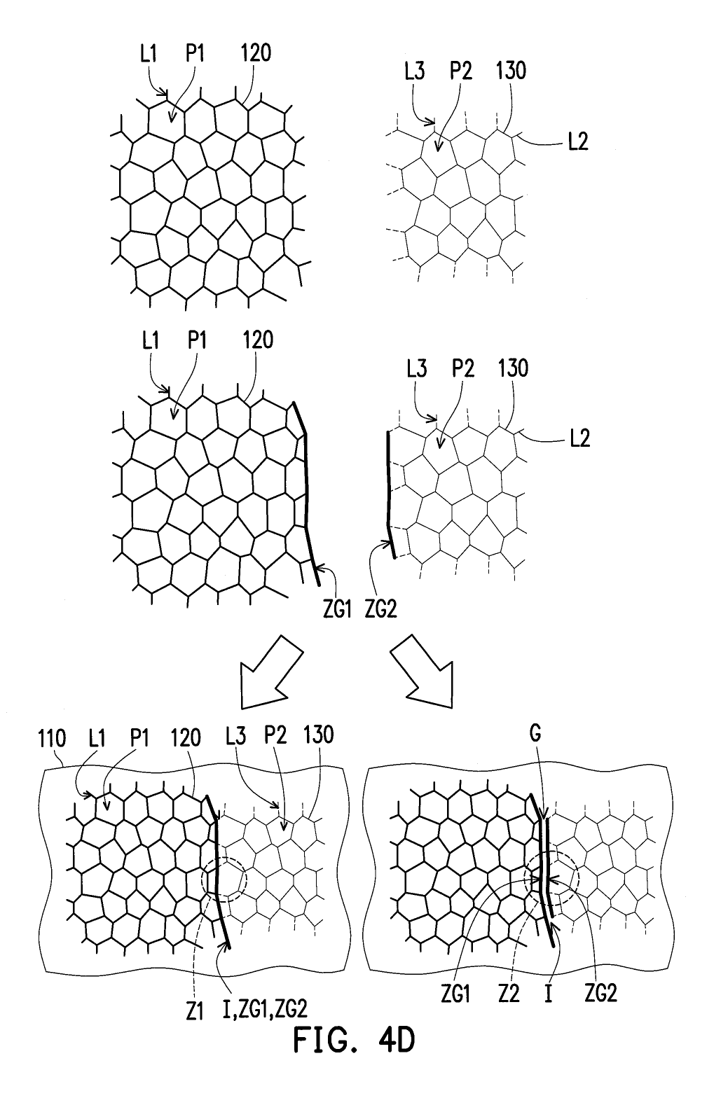

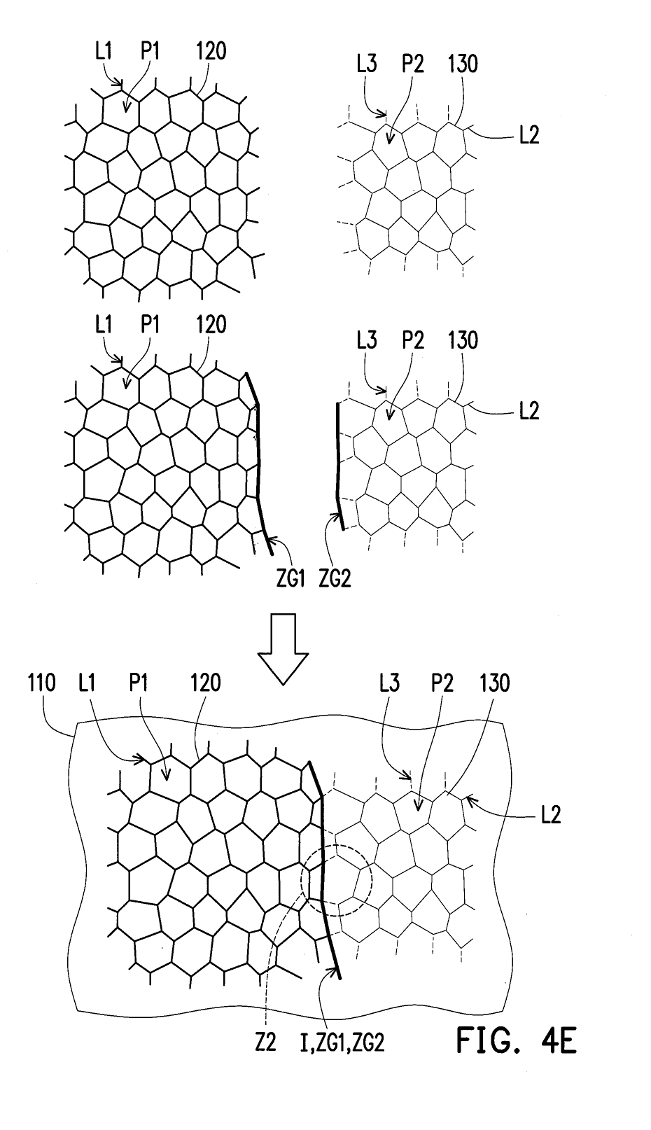

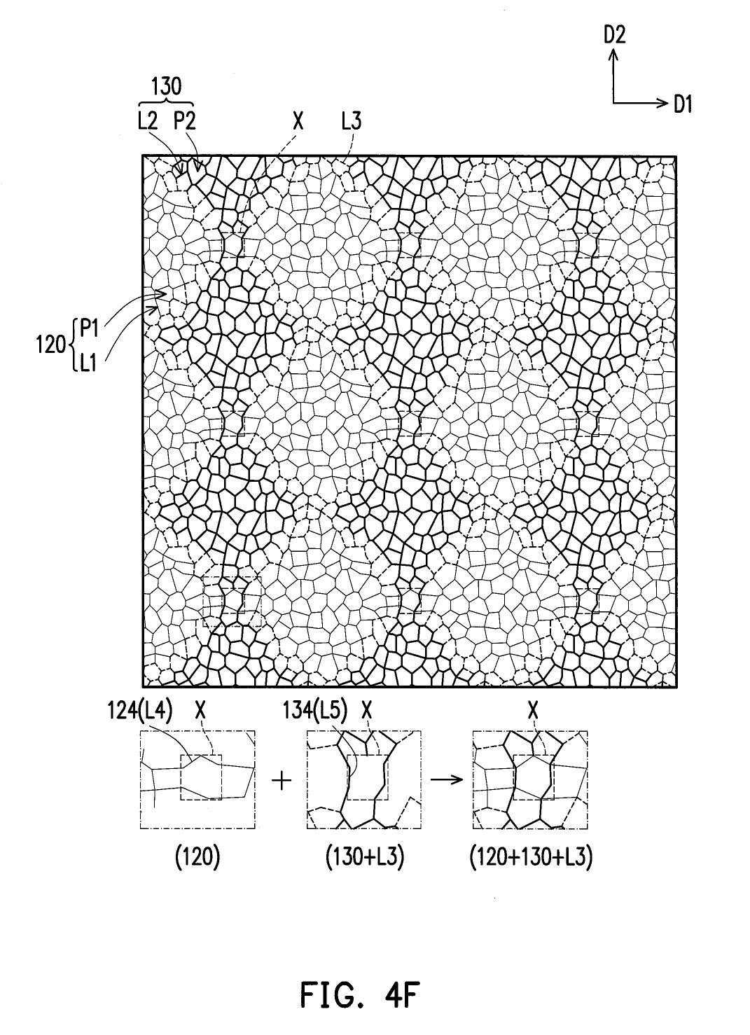

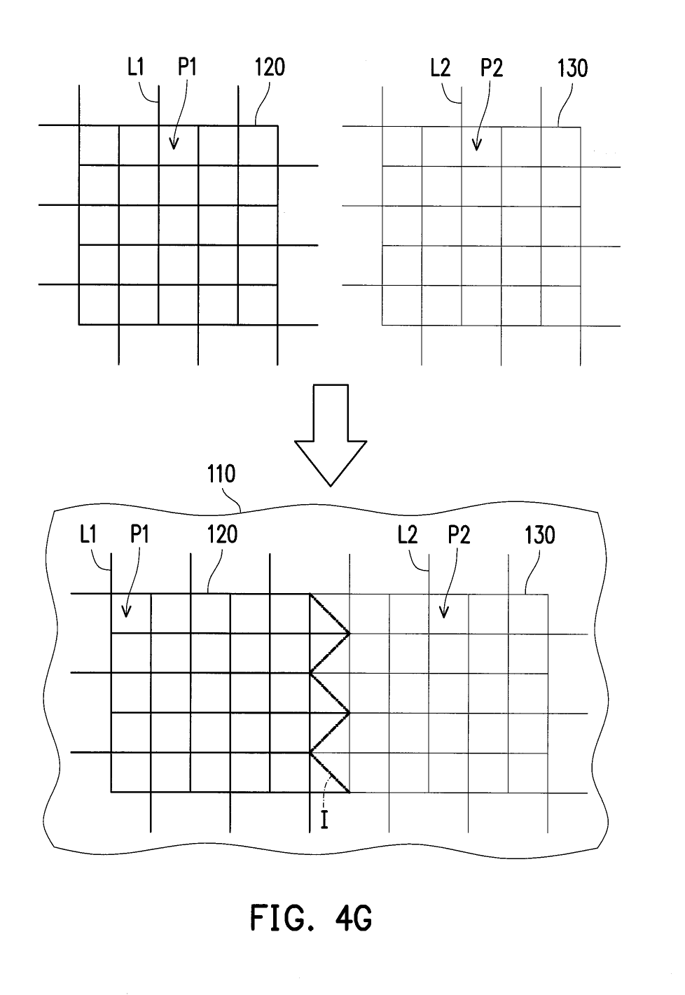

In actual productions, the first electrodes 120 and the second electrodes 130 are formed by cutting a whole plane of an irregular metal mesh, thus electrode patterns and stacking forms of the first electrodes 120 and the second electrodes 130 are not limited to the above. Hereinafter, FIG. 4A to FIG. 4G illustrate other electrode patterns and stacking forms of the first electrode 120 and the second electrode 130.

FIG. 4A to FIG. 4G illustrate other electrode patterns and stacking forms of the first electrode and the second electrode. In FIGS. 4A-4G, top parts illustrate forms of the first electrodes and the second electrodes before being stacked; middle parts illustrate the first zigzag line and the second zigzag line defined under above-said forms; and bottom parts illustrate forms of the first electrodes and the second electrodes after being stacked. In addition, illustration for above-said insulation layer is omitted in FIG. 4A to FIG. 4G.

As shown in FIG. 4A, each of the first electrodes 120 further includes a plurality of line segments L1, and each of the second electrodes 130 further includes a plurality of line segments L2. Therein, the line segments L1 are located at edges of each of the first electrodes 120 and connected to the first mesh patterns P1, and the line segments L2 are located at edges of each of the second electrodes 130 and connected to the second mesh patterns P2. Since one end of the line segments (e.g., line segments L1 and line segments L2) is connected to the mesh patterns (e.g., the first mesh patterns P1 and the second mesh patterns P2), while another end is suspended without connecting to one another, the first electrodes 120 and the second electrodes 130 of the present embodiment are of a non-closed electrode pattern.

Under an architecture of the non-closed electrode pattern, the first zigzag line ZG1 is, for example, defined by a virtual line connecting suspending end portions of each of the line segments L1, and the second zigzag line ZG2 is, for example, defined by a virtual line connecting suspending end portions of each of the line segments L2. As shown in a middle part of FIG. 4A, the virtual line is, for example, formed by connecting a shortest path between adjacent two end portions, but the invention is not limited thereto. As shown in a bottom left part of FIG. 4A, the first zigzag line ZG1 and the second zigzag line ZG2 may be overlapped with each other. Or, as shown in a bottom right part of FIG. 4A, the first zigzag line ZG1 and the second zigzag line ZG2 may be parallel to each other without overlapping with each other.

Despite that each of the first electrodes 120 and each of the second electrodes 130 are of the non-closed electrode pattern, orthogonal projections of the line segments L1 and L2, the first mesh patterns P1 and the second mesh patterns P2 on the substrate 110 may still compose a plurality of closed patterns Z1 (as shown in the bottom left part of FIG. 4A), or a plurality of closed-like patterns Z2 having a gap G (as shown in the bottom right part of FIG. 4A). It should be noted that, the figure only illustrates a part of the electrode patterns being connected from one single side, but the electrode patterns are practically an extension in plane. Therefore, the line segments L1 and L2 located at other sides may also be connected to adjacent electrode patterns, such that the orthogonal projections of the first electrodes 120 and the second electrodes 130 on the substrate 110 are the closed patterns Z1 or the closed-like patterns Z2 having the gap G.

In another embodiment, one of each of the first electrodes 120 and each of the second electrodes 130 may also be the closed electrode pattern while another one of the two being the non-closed electrode pattern. Further, the orthogonal projections of the first electrodes 120 and the second electrodes 130 after being stacked on the substrate 110 may be the closed patterns or the closed-lie patterns having the gap. For instance, as shown in FIG. 4B, each of the first electrodes 120 is, for example, the closed electrode pattern (the first electrode 120 does not include the line segments L1); each of the second electrodes 130 is, for example, the non-closed electrode pattern, and each of the second electrodes 130 further includes the line segments L2 connected to the second mesh patterns P2. However, in another embodiment not illustrated, the first electrode 120 may also the non-closed electrode pattern including the line segments L1, and the second electrode 130 is, for example, the closed electrode pattern not including the line segments L2.

Referring to a middle part of FIG. 4B, in the present embodiment, the first zigzag line ZG1 zigzags, for example, along routing of the first mesh patterns P1 located at the boundaries I between the first electrode 120 and the second electrode 130, and the second zigzag line ZG2 is, for example, defined by a virtual line connecting suspending end portions of each of the line segments L2.

As shown in a bottom left part of FIG. 4B, the first zigzag line ZG1 and the second zigzag line ZG2 may be partially overlapped with each other. Or, as shown in a bottom right part of FIG. 4B, the first zigzag line ZG1 and the second zigzag line ZG2 may be partially parallel to each other without overlapping with each other. In addition, orthogonal projections of the line segments L2 located on the boundaries I between the first electrode 120 and the second electrode 130, the first mesh patterns P1 and the second mesh patterns P2 on the substrate 110 compose a plurality of closed patterns Z1 (as shown in the bottom left part of FIG. 4B), or a plurality of closed-like patterns Z2 having a gap G (as shown in the bottom right part of FIG. 4B). The figure only illustrates a part of the electrode patterns being connected from one single side, but the electrode patterns are practically an extension in plane. Therefore, the line segments L2 located at other sides may also be connected to the adjacent first mesh patterns P1, such that the orthogonal projections of the first electrodes 120 and the second electrodes 130 on the substrate 110 are the closed patterns Z1 or the closed-like patterns Z2 having the gap G.

Furthermore, as shown in FIG. 4C, each of the first electrodes 120 may be a partially non-closed and partially closed electrode pattern. Similarly, each of the second electrodes 130 may also be a partially non-closed and partially closed electrode pattern. Under above-said architecture, the first zigzag line ZG1 is, for example, defined by a virtual line connecting suspending end portions of the line segments L1 together with the first mesh patterns P1 adjacent to the boundaries I, and the second zigzag line ZG2 is, for example, defined by a virtual line connecting suspending end portions of the line segments L2 together with the second mesh patterns P2 adjacent to the boundaries I. As shown in a bottom left part of FIG. 4C, the first zigzag line ZG1 and the second zigzag line ZG2 may be partially overlapped with each other. Or, as shown in a bottom right part of FIG. 4C, the first zigzag line ZG1 and the second zigzag line ZG2 may be partially parallel to each other without overlapping with each other. In addition, orthogonal projections of the line segments L1 and L2, the first mesh patterns P1 and the second mesh patterns P2 after being stacked on the substrate 110 are a plurality of closed patterns Z1 (as shown in the bottom left part of FIG. 4C), or a plurality of closed-like patterns Z2 having a gap G (as shown in the bottom right part of FIG. 4C).

In addition, as shown in FIG. 4D, at least one of each of the first electrodes 120 and each of the second electrode 130 may further include a plurality of floating line segments L3 located at edges of the at least one of each of the first electrodes 120 and each of the second electrodes 130 and connected to the at least one of the first electrodes 120 and the second electrodes 130. The embodiment is illustrated by using each of the second electrodes 130 including the floating line segments L3 for further description, but the invention is not limited thereto. In other embodiments, each of the first electrodes 120 may further include the floating line segments L3.

In the present embodiment, the floating line segments L3 may be, for example, manufactured together with the line segments L2 and the second mesh patterns P2 on the insulation layer 140 depicted in FIG. 2A at the same time. In addition, the second zigzag line ZG2 of the present embodiment is, for example, defined by a virtual line connecting suspending end portions of the floating line segments L3. In addition, orthogonal projections of the floating line segments L3, the line segments L1 and L2, the first mesh patterns P1 and the second mesh patterns P2 on the substrate 110 are substantially a plurality of closed patterns Z1 (as shown in the bottom left part of FIG. 4D), or a plurality of closed-like patterns Z2 having a gap G (as shown in the bottom right part of FIG. 4D). In another embodiment, the floating line segments L3 may also be manufactured together with the line segments L1 and the first mesh patterns P1 on the same layer and the first zigzag line ZG1 may be defined by a virtual line connecting suspending end portions of the floating line segments L3.

Furthermore, as shown in FIG. 4E, in case the floating line segments L3 are not connected to the line segments L1 and L2, the first mesh patterns P1 and/or the second mesh patterns P2, orthogonal projections of the floating line segments L3, the line segments L1 and L2, the first mesh patterns P1 and the second mesh patterns P2 on the substrate 110 are also, for example, of the closed-like patterns Z2.

It should be noted that, floating line segments L3 may also be further disposed in the architectures of FIG. 3B to FIG. 4C. In addition, the floating line segments L3 are not limited only to be manufactured together with the second mesh patterns P2 at the same time. More specifically, the floating line segments L3 may also be manufactured together with the first mesh patterns P1 at the same time. Or, the floating line segments L3 may also be manufactured, before the first mesh patterns P1 are manufactured, after the first mesh patterns P1 are manufactured and before the second mesh patterns P2 are manufactured, or after the first mesh patterns P1 and the second mesh patterns P2 are manufactured.

Since the first mesh patterns P1 and the second mesh patterns P2 are composed of irregular polygons, the deviations of the patterns may occur due to the changes in process parameters or poor alignment in case the first mesh patterns P1 and the second mesh patterns P2 are stacked. Accordingly, the orthogonal projections of the first mesh patterns P1 and the second mesh patterns P2 on the substrate 110 may not be in form of the closed patterns thereby influencing the visual effect. Therefore, in case the floating line segments L3 are manufactured after the first mesh patterns P1 and the second mesh patterns P2 are manufactured, the floating line segments L3 may be used for filling gaps between the first mesh patterns P1 and the second mesh patterns P2, such that the orthogonal projections of the floating line segments L3, the first mesh patterns P1 and the second mesh patterns P2 on the substrate 110 may form the closed patterns or the closed-like patterns each having the gap, so as to improve the visual effect of the touch panel.

In the embodiment of FIG. 4F, it is illustrated by manufacturing the floating line segments L3, the second mesh patterns P2 and the line segments at the same time for example, but the invention is not limited thereto. In view of FIG. 4F, it can be known that the first connecting lines 124 and the second connecting lines 134 may be composed of a plurality of line segments L4 and L5. Unlike the line segments L1 and L2 as described above, the line segments L4 and L5 each includes two ends respectively connected to the electrode pads, namely, the line segments L4 and L5 are configured to electrically connect adjacent two of the electrode pads.

Furthermore, as shown in FIG. 4G, the first mesh pattern P1 and the second mesh patterns P2 may also be of the regular polygons (with the same size and the same shape), after the first mesh patterns P1 and the second mesh patterns P2 are stacked, orthogonal projections of the line segments L1 and L2, the first mesh patterns P1 and the second mesh patterns P2 on the substrate 110 are the closed patterns.

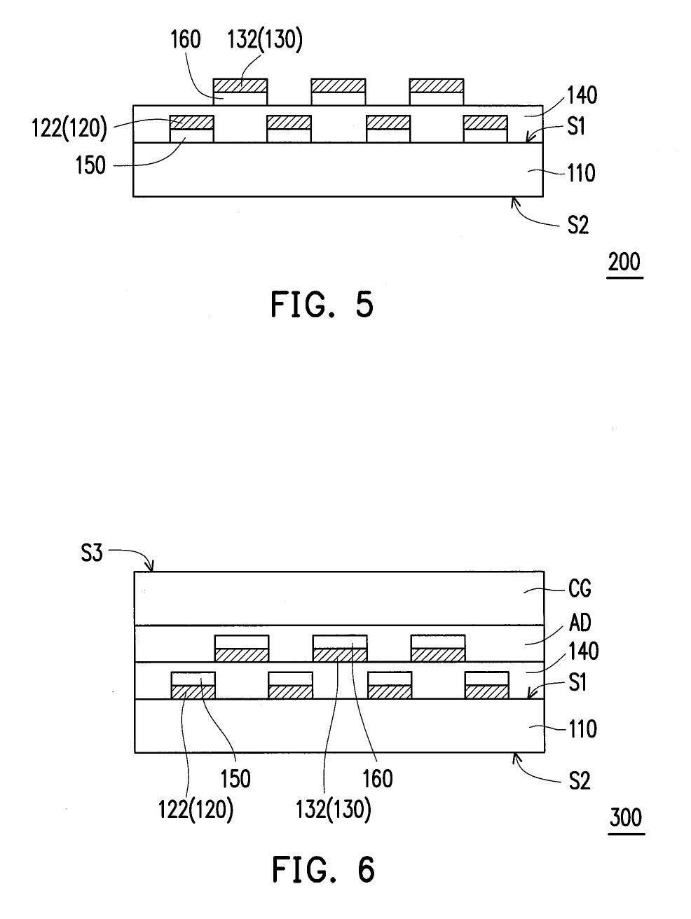

FIG. 5 is a schematically sectional view of a touch panel according to second embodiment of the invention. Referring to FIG. 5, a touch panel 200 of the present embodiment includes a structure similar to that of the touch panel 100 of FIG. 2B, and the first electrode 120 and the second electrode 130 of the touch panel 200 may be stacked by adopting the methods depicted in FIGS. 3B-4G. Therein, the same layers are indicated by the same reference numbers, thus materials, disposition and effects of the layers are omitted hereinafter. Unlike the touch panel 100, the touch panel 200 of the present embodiment further includes optical absorption layers 150 and 160 located on a surface of the first electrode 120 and the second electrode 130 facing a user, so as to further improve a visual effect of the touch panel 200. In the present embodiment, the substrate 110 is, for example, a cover plate; a surface S1 is, for example, a surface for disposing elements; and a surface S2 opposite to the surface S1 is, for example, a touch surface. Namely, a touching object contacts the surface S2 when a touch sensing is performed. Accordingly, the optical absorption layer 150 is disposed between the substrate 110 and the first electrodes 120, and the optical absorption layer 160 is disposed between the substrate 110 and the second electrodes 130.

In the present embodiment, a contour outline of the optical absorption layer 150 is, example, substantially identical to a contour outline of the first mesh patterns P1, and a contour outline of the optical absorption layer 160 is, for example, substantially identical to a contour outline of the second mesh patterns P2. However, the invention is not limited thereto. In other embodiments, the contour outlines of the optical absorption layers 150 and 160 may be greater than the contour outlines of the first mesh patterns P1 and the second mesh patterns P2, so as to improve the visual effect of the touch panel 200 in side vision. For instance, materials of the optical absorption layers 150 and 160 may be a metal, an alloy, a metal oxide, a resin optical absorption material or a black coating of carbon black, so as to scatter or absorb ambient light thereby lowering reflection of the first electrodes 120 and the second electrodes 130. The metal and the alloy may include, for example, chromium, nickel, molybdenum, titanium or an alloy of at least two of above. The metal oxide may be, for example, a copper oxide, a chromium oxide, a titanium oxide, a molybdenum oxide or a stack layer of at least two of above.

In addition, regardless of whether the optical absorption layer 160 is disposed, an entire or a patterned adhesion layer (not illustrated) may also be disposed between the second electrodes 130 and the insulation layer 140, so as to improve an adherence between the second electrodes 130 and the insulation layer 140 thereby improving a reliability of the touch panel 200.

FIG. 6 is a schematically sectional view of a touch panel according to third embodiment of the invention. Referring to FIG. 6, a touch panel 300 of the present embodiment includes a structure similar to that of the touch panel 200 of FIG. 5, and the first electrode 120 and the second electrode 130 of the touch panel 300 may be stacked by adopting the methods depicted in FIGS. 3B-4G. Therein, the same layers are indicated by the same reference numbers, thus materials, disposition and effects of the layers are omitted hereinafter. Unlike the touch panel 200, the substrate 110 of the touch panel 300 of the present embodiment is merely used to bear above-said layers, and the touch panel 300 may further include a cover plate CG and an adhesion layer AD. Therein, the first electrodes 120 and the second electrodes 130 are located between the substrate 110 and the cover plate CG, and the cover plate CG is bonded to the substrate 110 and the layers thereon through the adhesion layer AD, such that the adhesion layer AD is located between the cover plate CG and the second electrodes 130 and the insulation layer 140.

In the present embodiment, a surface S3 of the cover plate CG opposite to the adhesion layer AD is a touch surface. Accordingly, in the present embodiment, the optical absorption layer 150 is, for example, disposed between the first electrodes 120 and the insulation layer 140, and the optical absorption layer 160 is, for example, disposed between the second electrodes 130 and the adhesion layer AD. In the present embodiment, the optical absorption layer 150 is, for example, overlapped with the first electrodes 120 and includes a contour outline identical to that of the first electrodes 120, and the optical absorption layer 160 is, for example, overlapped with the second electrodes 130 and includes a contour outline identical to that of the second electrodes 130. However, the invention is not limited thereto. In other embodiments, the optical absorption layer 150 may further cover sidewalls of the first electrodes 120, and the optical absorption layer 160 may further cover sidewalls of the second electrodes 130.

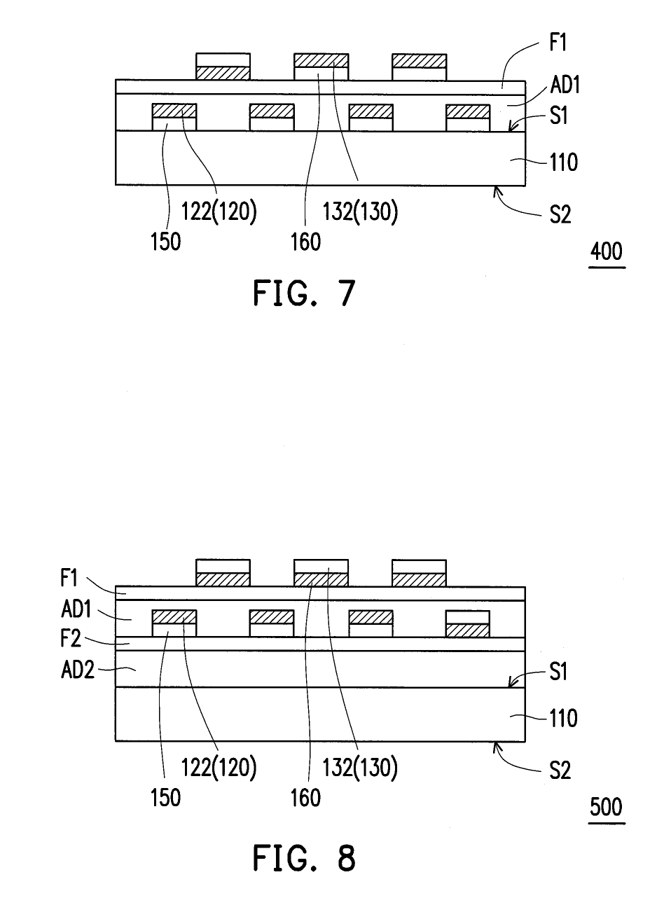

FIG. 7 is a schematically sectional view of a touch panel according to fourth embodiment of the invention. Referring to FIG. 7, a touch panel 400 of the present embodiment includes a structure similar to that of the touch panel 200 of FIG. 5, and the first electrode 120 and the second electrode 130 of the touch panel 400 may be stacked by adopting the methods depicted in FIGS. 3B-4G. Therein, the same layers are indicated by the same reference numbers, thus materials, disposition and effects of the layers are omitted hereinafter. Unlike the touch panel 200, the touch panel 400 of the present embodiment further includes a first insulation film F1. Therein, the second electrodes 130 are located on the first insulation film F1, and the first electrodes 120 are located between the first insulation film F1 and the substrate 110.

More specifically, the first electrodes 120 may be manufactured on the substrate 110, and the second electrodes 130 may be manufactured on the first insulation film F1. The first insulation film F1 is, for example, bonded to the first electrodes 120 and the substrate 110 through a first adhesion layer AD1. In another embodiment not illustrated, the first electrodes 120 and the second electrodes 130 may be manufactured on two opposite side of the first insulation film F1, and the first electrodes 120 and the first insulation film F1 may be bonded to the substrate 110 through the first adhesion layer AD1.

In the present embodiment, the substrate 110 may serve as the cover plate, namely, the surface S2 is the touch surface. Accordingly, the optical absorption layer 150 is, for example, disposed between the first electrodes 120 and the substrate 110, and the optical absorption layer 160 is, for example, disposed between the second electrodes 130 and the first insulation film F1. In another embodiment, the substrate 110 of the touch panel 400 is merely used to bear above-said layers, and the touch panel 400 may further include the cover plate CG and the adhesion layer AD as depicted in FIG. 6. The cover plate CG is bonded to the substrate 110 and the layers thereon through the adhesion layer AD, namely, the adhesion layer AD is located between the cover plate CG, and first insulation film F1 and the second electrodes 130. Moreover, as the touch surface is changed to the surface S3 of FIG. 6, a relative disposing relation between the first electrodes 120 and the optical absorption layer 150 and a relative disposing relation between the second electrodes 130 and the optical absorption layer 160 need to be changed correspondingly into relative disposing relations as depicted in FIG. 6 (i.e., exchanging positions).

FIG. 8 is a schematically sectional view of a touch panel according to fifth embodiment of the invention. Referring to FIG. 8, a touch panel 500 of the present embodiment includes a structure similar to that of the touch panel 400 of FIG. 7, and the first electrode 120 and the second electrode 130 of the touch panel 500 may be stacked by adopting the methods depicted in FIG. 3B to FIG. 4G. Therein, the same layers are indicated by the same reference numbers, thus materials, disposition and effects of the layers are omitted hereinafter. Unlike the touch panel 400, the touch panel 500 of the present embodiment further includes a second insulation film F2. Therein, the second insulation film F2 is located between the first electrodes 120 and the substrate 110. Moreover, the second insulation film F2 is, for example, bonded to the substrate 110 through a second adhesion layer AD2.

In the present embodiment, the substrate 110 serves as the cover plate. Accordingly, the optical absorption layer 150 is disposed between the first electrodes 120 and the substrate 110, and the optical absorption layer 160 is disposed between the second electrodes 130 and the first insulation film F1. In another embodiment, the substrate 110 of the touch panel 500 is merely used to bear above-said layers, and the touch panel 500 may further include the cover plate CG and the adhesion layer AD as depicted in FIG. 6. The cover plate CG is bonded to the substrate 110 and the layers thereon through the adhesion layer AD, namely, the adhesion layer AD is located between the cover plate CG, and first insulation film F1 and the second electrodes 130. Moreover, as the touch surface is changed to the surface S3 of FIG. 6, the relative disposing relation between the first electrodes 120 and the optical absorption layer 150 and the relative disposing relation between the second electrodes 130 and the optical absorption layer 160 need to be changed correspondingly into the relative disposing relations as depicted in FIG. 6.

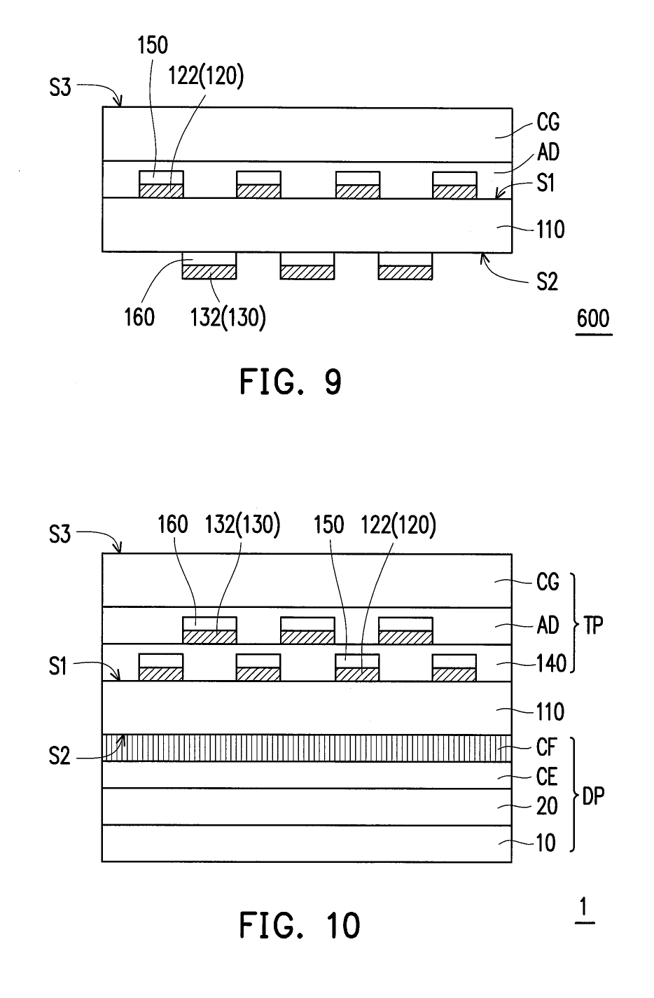

FIG. 9 is a schematically sectional view of a touch panel according to sixth embodiment of the invention. Referring to FIG. 9, a touch panel 600 of the present embodiment includes a structure similar to that of the touch panel 300 of FIG. 6, and the first electrode 120 and the second electrode 130 of the touch panel 600 may be stacked by adopting the methods depicted in FIG. 3B to FIG. 4G. Therein, the same layers are indicated by the same reference numbers, thus materials, disposition and effects of the layers are omitted hereinafter. Unlike the touch panel 300, the first electrodes 120 and the second electrodes 130 of the present embodiment are disposed on two opposite sides S1 and S2 of the substrate 110.

In the present embodiment, the cover plate CG is, for example, disposed on a side adjacent to the surface S1, thus the relative disposing relation between the optical absorption layer 150 and the first electrodes 120 is identical to the relative disposing relation between the optical absorption layer 150 and the first electrodes 120 as depicted in FIG. 6. On the other hand, the optical absorption layer 160 is, for example, disposed between the second electrodes 130 and the substrate 110. Or, in case the cover plate CG is disposed on a side adjacent to the surface S2, the relative disposing relation between the optical absorption layer 150 and the first electrodes 120 and the relative disposing relation between the optical absorption layer 160 and the second electrodes 130 need to be changed correspondingly.

It should be noted that, said touch panels 100, 200, 300, 400, 500 and 600 may be used together with a display panel to form a touch display panel in an out-cell type or an embedded type (which includes two forms of in-cell type and on-cell type). The out-cell type touch display panel refers to the touch panels 100, 200, 300, 400, 500 and 600 being bonded to the display panel directly though an adhesion layer. Under an architecture in which only the substrate is disposed (e.g., the touch panels 100, 200, 300 and 500), the surface S1 is located between the display panel and the surface S2. Under an architecture in which the substrate and the cover plate are disposed (e.g., the touch panels 300 and 600), the surface S1 and the surface S2 are located between the display panel and the surface S3.

Hereinafter, FIGS. 10-12 are the examples illustrating three implementations of the touch display panel. FIGS. 10-12 are implementations of a touch display panel applying the touch panel of the invention. Referring to FIG. 10, a touch display panel 1 of the present embodiment is, for example, an on-cell type touch display panel which includes a display panel DP and a touch panel TP. The display panel DP includes an active device array substrate 10, an opposite substrate (i.e., the substrate 110) and a display medium layer 20 located between the active device array substrate 10 and the opposite substrate.

In the present embodiment, the substrate 110 is used by both the display panel DP and the touch panel TP. In case the display panel DP is a liquid crystal panel, the substrate 110 serves, for example, as a color filter substrate. More specifically, in the substrate 110 of the present embodiment, the surface S1 is, for example, configured to bear touch elements (including the first electrodes 120, the second electrodes 130, the optical absorption layers 150 and 160, the insulation layer 140, the cover plate CG and the adhesion layer AD), whereas the surface S2 bears a part of elements of the display panel DP (e.g., a color filter CF, a common electrode CE and an alignment layer which is not illustrated). Further, the surface S3 of the cover plate CG is the touch surface. In addition, in case the display panel DP is an organic light-emitting diode panel, the substrate 110 may also serve as a packaging substrate of an organic light-emitting diode, and the packaging substrate may also be a color filter substrate.

It should be noted that, although the touch panel TP of the present embodiment is illustrated by using the touch panel 300 depicted in FIG. 6 for description, but the invention is not limited thereto. In other embodiments, the touch panel TP may also adopt the architectures of the touch panels 100, 200, 400 and 500. Nevertheless, in case the architectures of the touch panels 100, 200, 400 and 500 are adopted, the cover plate CG and the adhesion layer AD need to be further disposed, and the relative disposing relation between the first electrodes 120 and the optical absorption layer 150 and the relative disposing relation between the second electrodes 130 and the optical absorption layer 160 need to be changed correspondingly into the relative disposing relations as depicted in FIG. 6.

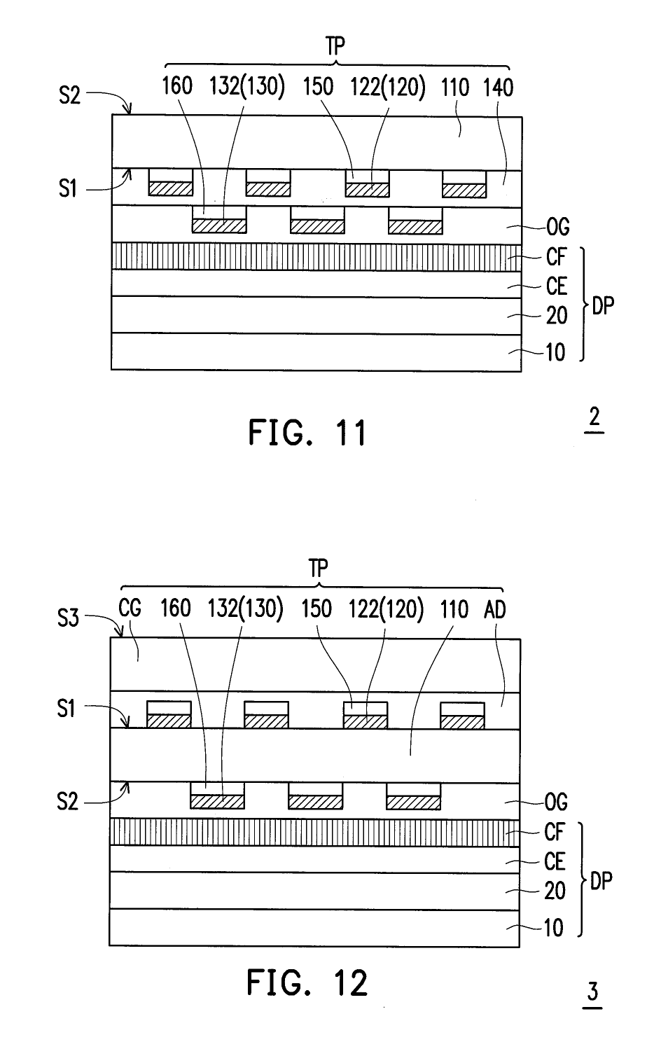

Referring to FIG. 11, a touch display panel 2 of the present embodiment includes layers similar to that of the touch display panel 1, and the same elements are indicated by the same reference numbers, thus related description thereof is omitted hereinafter. Unlike the touch display panel 1, the touch display panel 2 is an in-cell type touch display panel. More specifically, the touch display panel 2 further includes a dielectric layer OG located between the display panel DP and the touch panel TP. Further, the color filter CF, the common electrode CE and the alignment layer (not illustrated) of the display panel DP together with, for example, the touch elements (including the first electrodes 120, the second electrodes 130, the optical absorption layers 150 and 160, the insulation layer 140 and the cover plate CG) use the substrate 110 of the touch panel TP. The substrate 110 serves, for example, as the cover plate. The color filter CF, the common electrode CE and the alignment layer (not illustrated) as well as the touch elements are all disposed on the surface S1 of the substrate, and the surface S2 of the substrate 110 may serve as the touch surface.

It should be noted that, although the touch panel TP of the present embodiment is illustrated by using the touch panel 200 depicted in FIG. 5 for description, but the invention is not limited thereto. In other embodiments, the touch panel TP may also adopt the architectures of the touch panels 100, 400 and 500.

Referring to FIG. 12, a touch display panel 3 of the present embodiment is, for example, an on-in cell type touch display panel. More specifically, the touch display panel 3 of the present embodiment includes partial architecture of the touch display panels 1 and 2, and the same elements are indicated by the same reference numbers, thus related description thereof is omitted hereinafter. Unlike the touch display panels 1 and 2, the touch display panel 3 adopts the touch panel 600 of FIG. 6, and the substrate 110 of the present embodiment serves, for example, as the color filter substrate. More specifically, the color filter CF, the common electrode CE and the alignment layer (not illustrated) of the display panel DP are disposed together with, for example, the second electrodes 130 and the optical absorption layer 160 on the surface S2 of the substrate 110, and the first electrodes 120 and the optical absorption 150 are disposed on the surface S1 of the substrate 110.

In all of the foregoing embodiments, the first electrodes 120 and the second electrodes 130 may be driven by using a mutual-capacitor. Namely, the first electrode 120 receives a driving signal provided by an external circuit, so that the second electrode 130 may generate a sensing signal to be detected by the external circuit, so as to sense a touch coordinate. In addition, the first electrodes 120 and the second electrodes 130 may also be driven by using a self-capacitor. Namely, the first electrode 120 (or the second electrode 130) receives a driving signal provided by an external circuit, so that the first electrode 120 (or the second electrode 130) itself may generate a sensing signal to be detected by the external circuit.

Furthermore, the insulation layer 140 as depicted in the embodiments of FIG. 2A, FIG. 2B, FIG. 5, FIG. 6 and FIG. 10 may selectively use an organic layer, an inorganic layer (e.g., SiO2 or SiNx), or a stack layer of the two, or use a mixed or hybrid insulation layer of the two (e.g., a polyimide insulation layer). A principal component of the polyimide insulation layer is polyimide, which can be doped with other organic or inorganic materials (e.g., doped with SiO2 or SiNx), so as to change or improve a chemical resistance or an optical property of the polyimide insulation layer. For example, a birefringence of the polyimide insulation layer may be reduced by adding SiO2 therein, and SiO2 accounts for 30% to 70%. In these embodiments, a thickness of the insulating layer 140 is preferably between 1 um to 25 um. As another example, the insulating layer 140 may also be an inorganic material containing S1 doped with other organic high molecular, which has a temperature resistance for more than 200° C. in order to facilitate subsequent high temperature electroplating process.

Moreover, in all of aforesaid embodiments, the method of composing the first and the second electrodes by using the mesh patterns may also include forming a fill adhesion layer (e.g., a photocurable adhesive), and imprinting the mesh patterns in the fill adhesion layer by using a jig followed by filling a metal material therein, so as to compose the first and the second electrodes.

Based on the above, the touch panel of the invention composes the first and the second electrodes by using the mesh patterns of the metal material. Accordingly, in comparison with the touch panel using indium tin oxide containing rare earth element indium as the material of the electrode pads, the material used in the invention may be easily obtained, and a price of the material is also inexpensive. Moreover, the intersections of the first and the second electrodes are formed by the mesh patterns being overlapped, and the first electrode pads and the second electrode pads all having a zigzag outer contour. Therefore, the touch panel of the invention may facilitate in lowering a probability of the outer contours of the first and the second electrodes and the intersections being noticed by the user, so that the touch panel may provide a favorable visual effect.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims and their equivalents.

What is claimed is:

1. A touch panel, comprising:
a substrate;
a plurality of first electrodes disposed on the substrate, each of the first electrodes having a plurality of first mesh patterns connected to one another, each of the first electrodes including a plurality of first electrode pads and a plurality of first connecting lines, and the first connecting lines connecting adjacent two of the first electrode pads in series; and
a plurality of second electrodes electrically insulated from the first electrodes and disposed on the substrate, each of the second electrodes having a plurality of second mesh patterns connected to one another, each of the second electrodes including a plurality of second electrode pads and a plurality of second connecting lines, and the second connecting lines connecting adjacent two of the second electrode pads in series,
wherein an outer contour of each of the first electrode pads is defined by a first zigzag line, an outer contour of each of the second electrode pads is defined by a second zigzag line, and the first zigzag lines and the second zigzag lines located at a boundary between the first electrode and the second electrode are parallel or partially parallel to each other.

2. The touch panel of claim 1, wherein the second connecting lines of the second electrodes are intersected with the first connecting lines of the first electrodes, the second mesh patterns are only overlapped with the first mesh patterns at intersections of the first electrodes and the second electrodes, and sidewalls of the first mesh patterns and the second mesh patterns located at boundaries between the first electrode pads and the second electrode pads are aligned to each other.

3. The touch panel of claim 1, wherein the first mesh patterns located at edges of the first electrode pads are overlapped with the second mesh patterns located at edges of the second electrode pads.

4. The touch panel of claim 1, wherein at least one of each of the first electrodes and each of the second electrodes further comprises a plurality of line segments located at edges of the at least one of each of the first electrodes and each of the second electrodes and connected to at least one of the first mesh patterns and the second mesh patterns of the at least one of each of the first electrodes and each of the second electrodes, wherein orthogonal projections of the line segments, the first mesh patterns and the second mesh patterns on the substrate are a plurality of closed patterns, or a plurality of closed-like patterns each having a gap.

5. The touch panel of claim 4, wherein at least one of the first zigzag line and the second zigzag line is defined by a virtual line connecting suspending end portions of the line segments.

6. The touch panel of claim 4, wherein at least one of the first zigzag line and the second zigzag line is defined by a virtual line connecting the at least one of the first mesh patterns and the second mesh patterns together with suspending end portions of the line segments.

7. The touch panel of claim 4, wherein at least one of each of the first electrodes and each of the second electrodes further comprises a plurality of floating line segments located at edges of the at least one of each of the first electrodes and each of the second electrodes, wherein at least one of the first zigzag line and the second zigzag line is defined by a virtual line connecting suspending end portions of the floating line segments, and orthogonal projections of the floating line segments, the line segments, the first mesh patterns and the second mesh patterns on the substrate are a plurality of closed patterns, or a plurality of closed-like patterns each having a gap.

8. The touch panel of claim 7, wherein the floating line segments are connected to the at least one of the first mesh patterns and the second mesh patterns.

9. The touch panel of claim 7, wherein the floating line segments are not connected to at least one of the line segments, the first mesh patterns and the second mesh patterns.

10. The touch panel of claim 1, further comprising a plurality of floating line segments located at edges of at least one of each of the first electrodes and each of the second electrodes and not connected to the first mesh patterns and the second mesh patterns, wherein orthogonal projections of the floating line segments, the first mesh patterns and the second mesh patterns on the substrate are a plurality of closed patterns, or a plurality of closed-like patterns each having a gap.

11. The touch panel of claim 1, wherein the first mesh patterns and the second mesh patterns are regular polygons or irregular polygons.

12. The touch panel of claim 1, wherein average side lengths of the first mesh patterns and the second mesh patterns fall within a range between 50 μm to 300 μm.

13. The touch panel of claim 1, further comprising at least one optical absorption layer located on a surface of the first electrodes and the second electrodes facing a user.

14. The touch panel of claim 1, further comprising an insulation layer disposed on the substrate and the first electrodes, and the second electrodes being located on the insulation layer.

15. The touch panel of claim 14, wherein a thickness of the insulation layer is less than or equal to 100 times a line width of the first mesh patterns or the second mesh patterns.

16. The touch panel of claim 14, wherein a thickness of the insulation layer falls within a range between 0.1 μm to 90 μm.

17. The touch panel of claim 14, wherein a difference between a refractive index of the insulation layer and a refractive index of the substrate is less than 30%.

18. The touch panel of claim 1, further comprising a cover plate, and at least one of the first electrodes and the second electrodes being located between the substrate and the cover plate.

19. The touch panel of claim 1, further comprising a first insulation film, the second electrodes being located on the first insulation film, and the first electrodes being located between the first insulation film and the substrate.

20. The touch panel of claim 19, further comprising a second insulation film located between the first electrodes and the substrate.
